(19) United States
(12) Patent Application Publication
(10) Pub. No.: US 2016/0189461 A1
(43) Pub. Date: Jun. 30, 2016

(54) NEAR FIELD COMMUNICATION (NFC) BASED VENDOR/CUSTOMER INTERFACE

(71) Applicants: Avi Kanon, Jerusalem (IL); Yosef H. Ezra, Jerusalem (IL); Itai Peres-Peretz, Jerusalem (IL); Ned M. Smith, Beaverton, OR (US)

(72) Inventors: Avi Kanon, Jerusalem (IL); Yosef H. Ezra, Jerusalem (IL); Itai Peres-Peretz, Jerusalem (IL); Ned M. Smith, Beaverton, OR (US)

(21) Appl. No.: 14/751,911

(22) Filed: Jun. 26, 2015

Related U.S. Application Data
(60) Provisional application No. 62/097,063, filed on Dec. 27, 2014.

(51) Int. Cl. G07C 13/00; H04L 29/06; H04W 12/04; G06Q 20/18; H04W 4/00

(52) U.S. Cl. CPC G07C 13/00; G06Q 20/18; H04W 4/008; H04W 12/04; H04L 63/061; H04L 63/0492; G06Q 2220/10

(57) ABSTRACT

Methods and systems to interface between an intelligent vendor kiosk (e.g., a restaurant table), and a mobile user/customer device(s) based at least in part on near field communications, including targeting content (e.g., a menu and/or advertisements) based on context, determining context based on user/customer-selected personal profile attributes and/or customer-selected advertisements, and determining a group context for a group customers with an additive homomorphic voting protocol to preclude disclosure of the votes of each customer to other customers and to the kiosk.

### CROSS REFERENCE TO RELATED APPLICATIONS

This application claims the benefit of U.S. Provisional Patent Application No. 62/097,063, filed Dec. 27, 2014, which is incorporated herein by reference in its entirely.

### BACKGROUND

A dining or restaurant experience may include waiting for an available table/seats, waiting for a waiter/waitress to provide menus, deciding what to order from the menu, calling the waiter to order a meal, waiting for the meal to be prepared and delivered to the table, consuming the meal, selecting and ordering additional food items such as drinks or desert, requesting a bill from the waiter/waitress, waiting for the waiter/waitress to deliver the bill, waiting for the waiter to return to retrieve payment for the bill, and waiting for the waiter to return with change and/or payment receipt. Thus, only a relatively small portion of the overall time may be spent consuming food/drink.

Advertisements may be targeted to a person based on personal preferences or interests of the person. In some situations, such as a restaurant, it may be socially awkward for a person/customer to provide personal information in the presence of others. The person/customer may object if personal information is retrieved from a device of the customer without approval of the customer.

A near field communication (NFC) device is a relatively short-range communication device. NFC devices communicate based on near field electromagnetic induction between loop antennas of the respective devices. NFC devices may initiate communication when in relatively close proximity of one another (e.g., a few inches or less), referred to herein as a NFC “tap.” A NFC device may be configured as a NFC target (also referred to herein as a NFC credential, a NFC transmitter, a NFC sticker), a NFC initiator (also referred to herein as a NFC reader and a NFC receiver), and/or a NFC peer. A NFC device form factors include tags, stickers, key fobs, and cards. A NFC device may be configured as an active device (e.g., battery powered) or a passive device (I.e., powered by a near field of an active NFC device).

A smart device may include a processor to execute an application(s)/program(s), and a communication system to communicate with other devices and/or systems via one or more wired and/or wireless communication protocols, and/or may exhibit one or more properties of ubiquitous computing. Smart devices come in a variety of form factors, such as smart phones (e.g., an integrated mobile telephone and smart computing platform).

### BRIEF DESCRIPTION OF THE DRAWINGS

For illustrative purposes, one or more features disclosed herein may be presented and/or described by way of example and/or with reference to one or more drawing figured listed below. Methods and systems disclosed herein are not, however, limited to such examples or illustrations.

FIG. 1 is an illustration of a vendor/customer environment that includes an interactive vendor kiosk (e.g., a restaurant table) to interface with a mobile user/customer device through respective near field communication (NFC) devices, a vendor server system to interact with the mobile user/customer device through a wireless access point, and a mobile hostess device to interact with the interactive kiosk, the vendor server system, and/or the mobile user/customer device.

FIG. 2 is a flowchart of a method of interacting amongst a mobile user/customer device, an interactive vendor kiosk, and a vendor server system.

FIG. 3 is a sequence diagram of an example interactive restaurant experience based on features described herein above with reference to FIGS. 1 and 2.

FIG. 4 is a flowchart of a method of interfacing amongst a mobile user/customer device, an interactive kiosk, and a hostess device.

FIG. 5 is a flowchart of a method of presenting content to a customer at an interactive kiosk, and selectively transferring related content to a mobile customer device based on customer interactions with the kiosk.

FIG. 6 is a flowchart of a method of interacting amongst an interactive kiosk and multiple mobile user/customer devices.

FIG. 7 is an illustration of a customer/vendor environment that includes an interactive kiosk, multiple mobile user/customer devices, a mobile hostess device, and a wireless access point to access a vendor server system.

FIG. 8 is a block diagram of an interactive kiosk and a mobile user/customer device, configured to provide private customer voting and additive homomorphic encryption vote tallying.

FIG. 9 is an illustration of a customer/vendor environment that includes an interactive kiosk, multiple mobile user/customer devices, and a mobile hostess device.

FIG. 10 is a flowchart of a method of determining a group context based on additive homomorphic vote encryption, and selecting/targeting content (e.g., menu items and/or advertisements/offers) based on the group context.

FIG. 11 is a block diagram of computer system configured as an interactive kiosk computer system.

FIG. 12 is a block diagram of computer system configured as a user or customer device.

FIG. 13 is a block diagram of a mobile device that includes a processor and memory, a NFC device, a network interface device, and a user interface.

In the drawings, the leftmost digit(s) of a reference number identifies the drawing in which the reference number first appears.

### DETAILED DESCRIPTION

For illustrative purposes, methods and systems are described herein with respect to restaurant dining experiences. Methods and systems disclosed herein are not, however, limited to restaurants or dining experiences.

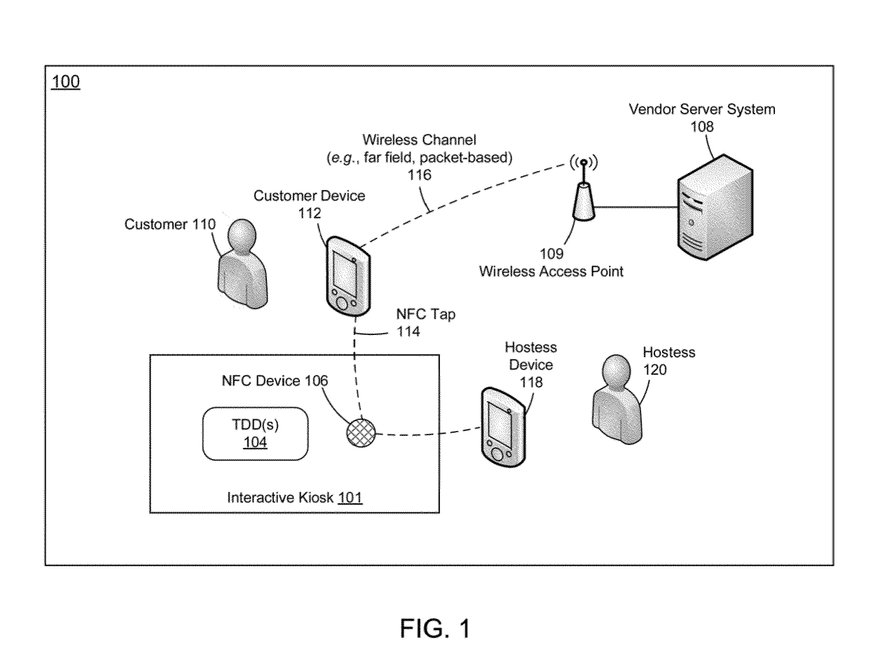

FIG. 1 is an illustration of a vendor/customer environment that includes an interactive vendor kiosk (kiosk) 101, to interface with a customer device 112 through respective near field communication (NFC) devices, and a vendor server system 108 to interact with customer device 112 through a wireless access point 109.

Kiosk 101 may represent or include a counter or table of a restaurant. Kiosk 101 may referred to herein as a table 101. Kiosk 101 includes a customer interface system, illustrated here as including a display 104. Display 104 may also be referred to herein as a table display device (TDD). Display 104 may be positioned to present content to a customer 110, and may be attached or mounted to kiosk 101. Display 104 may include a touch sensitive screen to receive customer input. The customer interface system may further include audio speakers and/or a customer input device (e.g., a keyboard, pointer/cursor control device, and/or microphone). Display 104 may include a touch sensitive screen to receive customer input.

Kiosk 101 may further include a computer system (e.g., a processor and memory), to manage the user interface system, such as to present content through the user interface system, and/or to receive customer input through the user interface system. Alternatively, or additionally, a vendor server system 108 may be configured to manage the user interface system.

Kiosk 101 further includes a near field communication (NFC) device 106 to communicate with an NFC device of customer device 112. Customer device 112 may be configured as a smart device such as, without limitation, a smart phone a smartphone, tablet, and/or a radio frequency identification (RFID) inductively charged capacitance device.

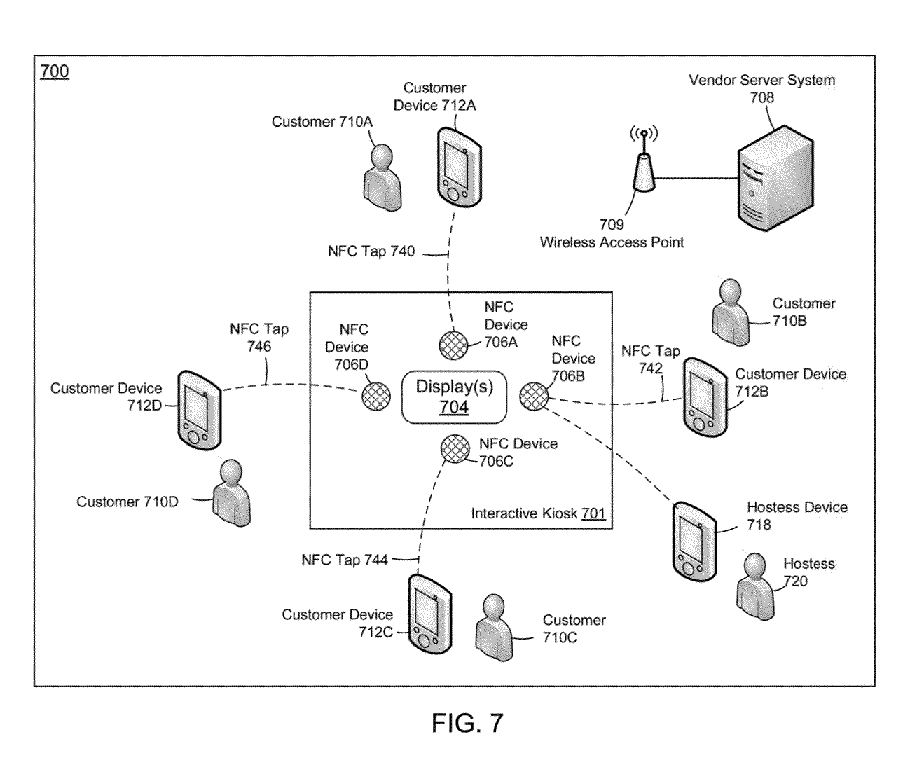

Kiosk 101 may include multiple displays 104 and/or multiple NFC devices 106, such as described further below with reference to FIG. 7. Multiple displays and/or multiple NFC devices may be useful to support interactions with a group of customers at an interactive kiosk.

Vendor server system 108 and customer device 112 may be configured to communicate over a wireless channel 116 (e.g., a far field communication link), based on a packet-based communication protocol.

Environment 100 may further include a NFC-enabled mobile hostess device (hostess device) 118, to communicate with kiosk 101 and/or customer device 112 through respective NFC devices, and/or to communicate with vendor server system 108 through wireless access point 109. Hostess device 118 may be associated with a person designated by a vendor to interface with customer 110, such as a waitress/waiter, maître d', and/or concierge. Hostess device 118 may be configured as a smart device.

Kiosk 101, vendor server system 108, and/or hostess device 118 may be configured to enhance a dining experience of customer 110 via display 104 and/or via a display of customer device 112.

Customer device 112 may include a processor and memory to execute a vendor interface application (VIA), and the VIA may be configured to cause the processor to interact with kiosk 101, vendor server system 108, and/or hostess device 118, such as described in one or more examples herein.

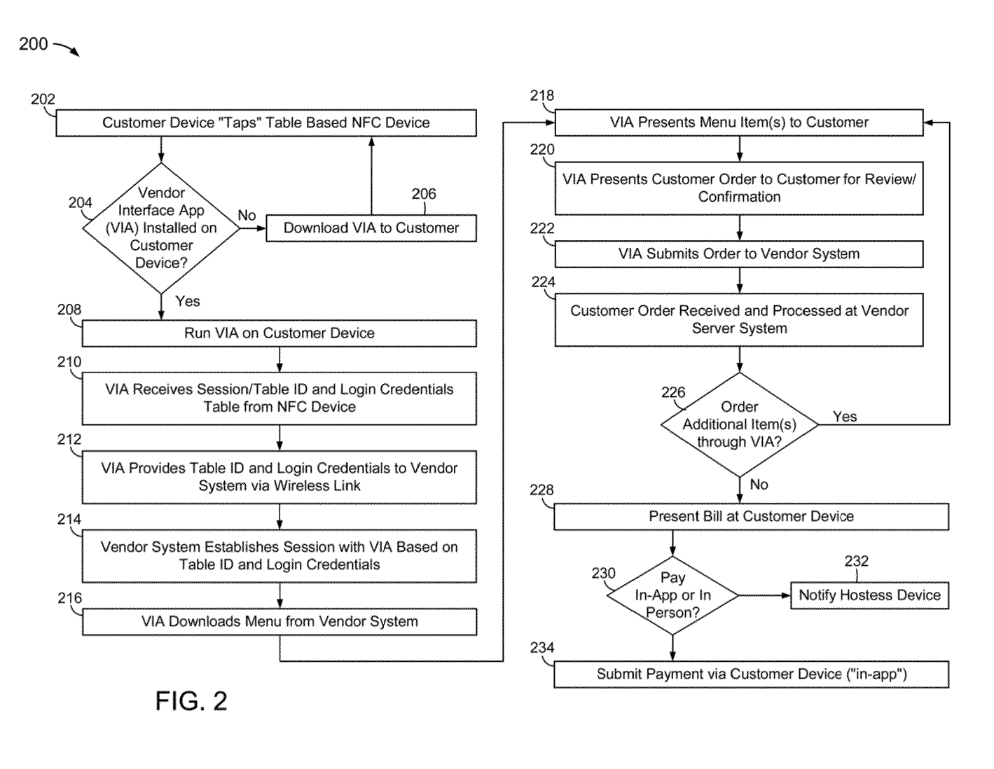

FIG. 2 is a flowchart of a method of interfacing amongst a mobile user/customer device, an interactive vendor kiosk, and a vendor server system. Method 200 is described below with respect to a dining experience and with reference to environment 100 in FIG. 1. Method 200 is not, however, limited to dining experiences or environment 100.

At 202, upon being seated at table 102, customer 110 places customer device 112 relatively close to NFC device 106, such that customer device 112 is within a near field of NFC device 106. This is illustrated in FIG. 1 as a NFC tap 114.

At 204, a determination is made as to whether a vendor interface application (VIA) is installed on customer device 112. The determination may be made by customer device 112 based a prompt/instruction from NFC device 106 to execute (i.e., load, launch, or run) the VIA on customer device 106.

At 206, if the VIA is not installed on customer device 112, customer device 112 may receive the VIA from NFC device 106, or may retrieve or download the VIA based on information received from NFC device 106. Customer device 112 may, for example, receive a uniform resource identifier (URI) from NFC device 106, and may download the VIA from the URI (e.g., via wireless Internet communication).

At 208, the VIA is executed on customer device 112.

At 210, the VIA executing on customer device 112 receives a session identifier (ID) and login credentials from NFC device 106. The session ID may represent a kiosk or table number. The login credentials may include a name or ID (e.g., a SSID) and/or password to access vendor server system 108 through access point 109.

At 212, the VIA causes customer device 112 to transmit the session ID and login credentials to wireless access point 109.

At 214, wireless access point 109 and/or vendor server system 108 establishes a session with the VIA over wireless channel 116 based on the session ID and login credentials. Example interactions amongst vendor system 108 and the VIA, during the session, are provided below with reference to 216 through 234 in FIG. 2.

At 216, the VIA downloads a menu from vendor server system 108. The menu includes a listing of goods and/or services (e.g., food items), available from the vendor/restaurant.

At 218, the VIA presents the menu to customer 110. The VIA may present the menu as customer-selectable items on a display of customer device 112.

The VIA may download additional information related to items of the menu at 216, and may present the additional information to customer 110 at 218. The additional information may relate to the menu and include, for example, menu item prices, descriptions, pictures, and/or review of other customers.

At 220, the VIA receives menu selections from customer 110, and presents the menu selections to customer 110 for review, confirmation, and/or modification. The VIA may present a “place order” icon on the display of customer device 112 to permit customer 110 to submit the order to vendor server system 108.

At 222, upon confirmation of the menu selections by customer 110, the VIA submits the menu selections as a customer order to vendor server system 108. The VIA may submit the session IS (e.g., table number), with the order.

At 224, the customer order is received and processed by vendor server system 108. Vendor server system 108 may, for example, route the order to a restaurant kitchen for preparation. Vendor server system 108 and/or the VIA may be configured to provide customer 110 with an order status and/or status update(s), and/or may be configured to provide customer 110 with an estimated time to delivery of the order. Vendor server system 108 may send a message to hostess device 118 when the order is ready to serve to customer 110.

At 226, customer 110 may elect to order addition menu items (e.g., drinks, coffee, and/or desert).

The VIA may present a customer selectable “call waiter” icon, to permit customer 110 to request hostess 120. Upon selection of the icon by customer 110, the VIA may send a notification to hostess device 118 (e.g., via vendor server system 108), to alert hostess 120. The notification may include the session/table ID provided at 210.

At 228, the VIA presents a bill to customer 110 (e.g., on the display of customer device 112). The VIA may receive the bill from vendor server system 108, or may compute the bill based on the customer order(s) submitted to vendor server system 108.

At 230, the VIA prompts customer 110 to pay the bill. The prompt may permit customer 110 to elect to pay the bill in-person and/or through customer device 112 (e.g., through the VIA and/or other application(s) on customer device 112). Payment through customer device 112 and/or through the VIA is referred to herein as an in-app payment.

If customer 110 elects to pay in-person (e.g., via the call waiter icon), at 232 the VIA sends a notification to hostess device 118. Customer 210 may then present cash and/or a financial transaction card to hostess 120.

If customer 110 elects to pay in-app, at 234 the VIA may initiate and/or assist with a corresponding payment transaction.

The VIA may present customer 110 with multiple in-app payment options. The in-app payment options may include a conventional mode of electronic payment (e.g., a bank, credit, and/or debit account), a virtual/digital/crypto currency payment option, (e.g., BitCoin), an Internet-based fund transfer/payment option (e.g., PayPal), a NFC-based payment option, and combinations thereof.

The VIA may be configured to interface between customer 110 and a computer-accessible payment portal (e.g., a URL associated payment mode), and may be configured to provide the session/table ID to the payment portal during the payment transaction.

For an NFC-based payment, the VIA may be configured to permit customer 110 to pay the bill by tapping a NFC capable financial transaction card to customer device 110 or to NFC device 106 of kiosk 101. In this example, the bill is charged to a financial account associated with the NFC capable financial transaction card.

When the bill is paid, payment confirmation (and the session/table ID) may be sent to vendor server system 108 by the VIA on customer device 110 and/or by a payment portal or payment processor.

The VIA may be configure to permit customer 110 to split the bill, such as to pay the bill with a combination of in-app payment options, and/or to pay a portion of the bill in-person.

In-app payment permits customer 110 to avoid presenting a financial account information to the restaurant and/or its employees, which may help to avoid unauthorized charges to and/or fraudulent use of the financial account.

The VIA on customer device 112 may prompt and/or permit customer 110 to rate items ordered by customer 110 for viewing by other customers.

The VIA may be configured to interface with vendor server systems of multiple vendors, such that customer 110 may dine at multiple restaurants through a single VIA application on customer device 112. This may be useful to permit customer 110 to utilize customer device 112 to connect seamlessly to wireless networks of the various restaurants (e.g., without having to rely on a wireless network of 3^{rd} party network service provider). This may also be useful to permit the VIA to update a personal profile of customer 110 based on experiences of customer 110 at multiple vendor establishments. Personal profiles are discussed further below.

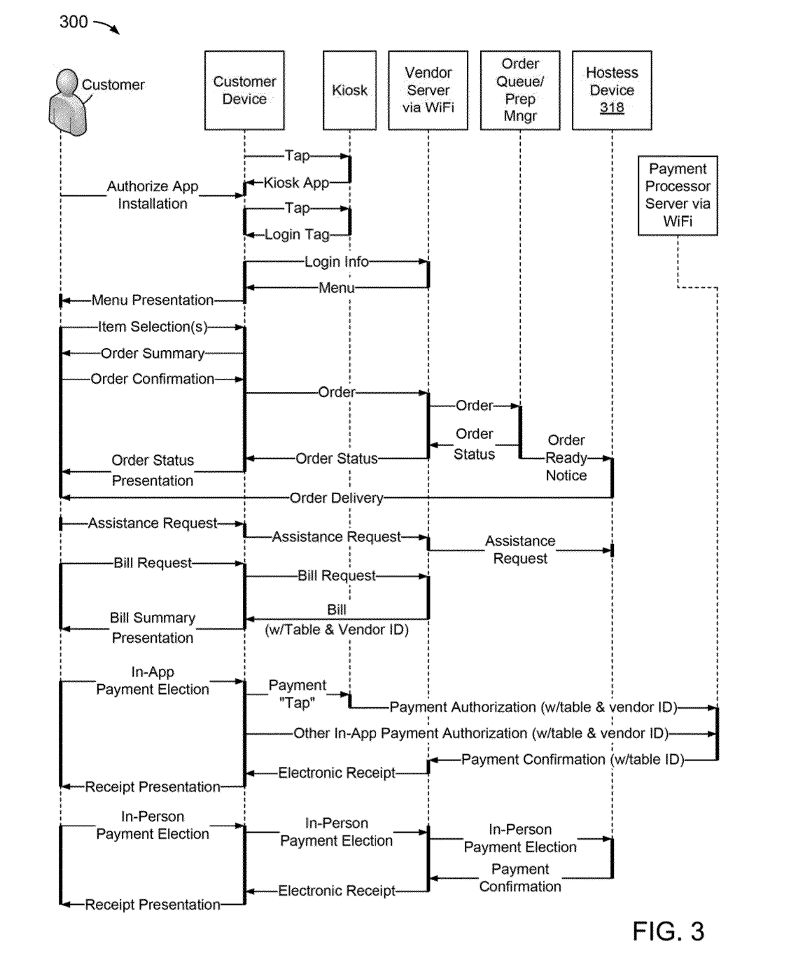

FIG. 3 is a sequence diagram 300 of an example interactive restaurant experience based on features described above with reference to FIGS. 1 and 2. Efficiencies of an interactive restaurant experience as disclosed herein are evident from a relatively small number of interactions with a hostess device 318. Methods and systems disclosed herein may thus be useful to avoid and/or reduce the time involved in a restaurant experience, using a mobile smart device such as smart phone/tablet with NFC support.

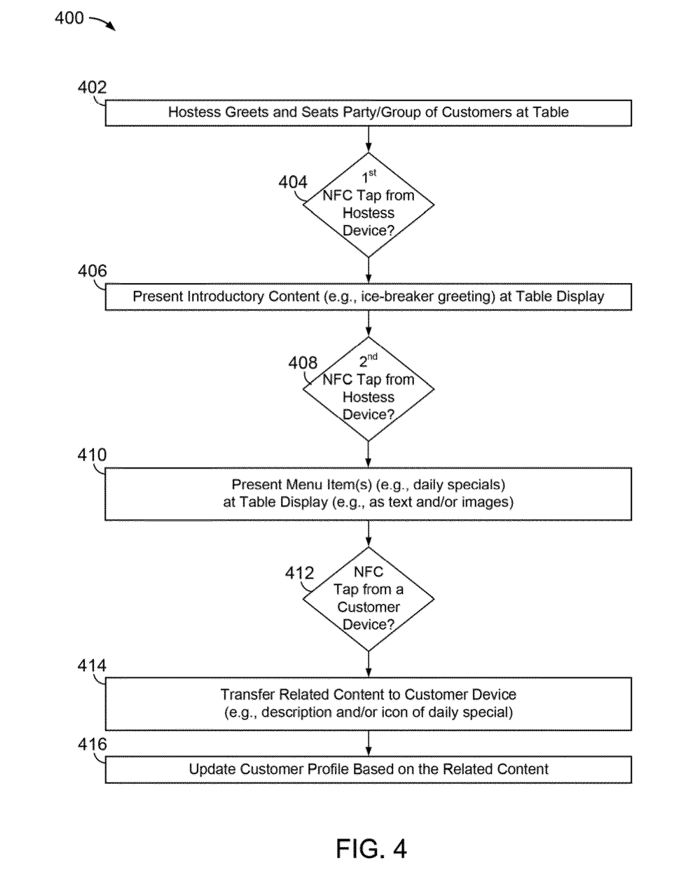

In FIG. 1, hostess device 118 may be configured to interact with kiosk 101 through respective NFC devices. Kiosk 101 may, for example, be configured to present content at display 104 when hostess device 118 is tapped to NFC device 106. Examples are provided below with reference to FIG. 4.

FIG. 4 is a flowchart of a method 400 of interfacing amongst an interactive kiosk, a hostess device, and a customer device. Method 400 is described below with respect to a dining experience and with reference to environment 100 in FIG. 1. Method 400 is not, however, limited to dining experiences or environment 100.

At 402, hostess 120 seats customer 110 at table 102.

At 404, if hostess 120 taps hostess device 118 to NFC device 106, kiosk 101 presents introductory content at 406. The introductory content may be presented on display 104 in FIG. 1. The introductory content may include, without limitation, a name, brief history, and/or interests of hostess 120, and/or other content designed to make customer 110 feel comfortable. This may be useful, such as to build rapport with customer 110 (e.g., to “break the ice”).

At 410, kiosk 101 presents a menu (e.g., at display 104 in FIG. 1). The menu may be presented in response to the NFC tap from hostess device 118 at 404, in response to a second NFC tap from hostess device at 408, and/or in response to a subsequent NFC tap from customer device 112. The menu presented at 410 may include a daily special or other specialty dishes. Each menu item may be presented at 410 for a time sufficient to permit hostess 130 to describe the items.

At 412, if customer 110 taps customer device 112 to NFC device 106 while a menu item is presented or highlighted at display 104, content related to the menu item is transferred to customer device 112 at 414. The related content may be presented at customer device 112. The content may include an icon corresponding to the item, and/or a description of the item. The icon and/or description may be presented on the display of customer device 112.

At 416, a profile of customer 112 is updated to reflect that the customer expressed an interest in and/or preference for the menu item at 412. The profile may reside on customer device 112, and may be updated by the VIA executing on customer device 112.

Enhancement of a dining experience may include presenting targeted content to a customer(s), at an interactive kiosk and/or at a customer device(s). Targeted content may include, without limitation, menu items, offers, and/or advertisements. Menu targeting may include selecting items list in a menu based on a customer or a group of customers. Targeted offers and/or advertisements may relate to goods and/or services available from a vendor/restaurant associated with the kiosk, and/or goods/services available from other another vendor(s). Such other vendors are referred to herein as a 3^{rd} party vendors or advertisers.

Content may be targeted based on a context associated with a customer and/or associated with a group of customers. A customer context may be determined from attributes of a personal profile and/or preferences of a customer. A group context may be determined from shared or shamble attributes of personal profiles and/or preferences of a group of customers. A group context may be further based on, and/or may represent a relationship amongst a group of customers (e.g., a purpose or reason for which the customers are together at a kiosk/restaurant table). Context may be further based on an environmental factor(s), which may be obtained from a sensor(s) of a customer device.

In FIG. 1, a profile of customer 110 may be stored in a secure location of customer device 112, and the VIA on customer device 112 may be configured to access, populate, and/or update the profile in a secure processing environment of customer device 112.

The VIA may be configured to populate and/or update the profile of customer 110 based on menu items ordered by customer 110 (e.g., at 222 in FIG. 2), NFC based interactions between customer device 112 and kiosk 101 (e.g., at 412 in FIG. 4), and/or based on other information accessible to the VIA. The profile of customer 110 may include preferences of customer 110, which may relate to menu/food items, interests, and/or features.

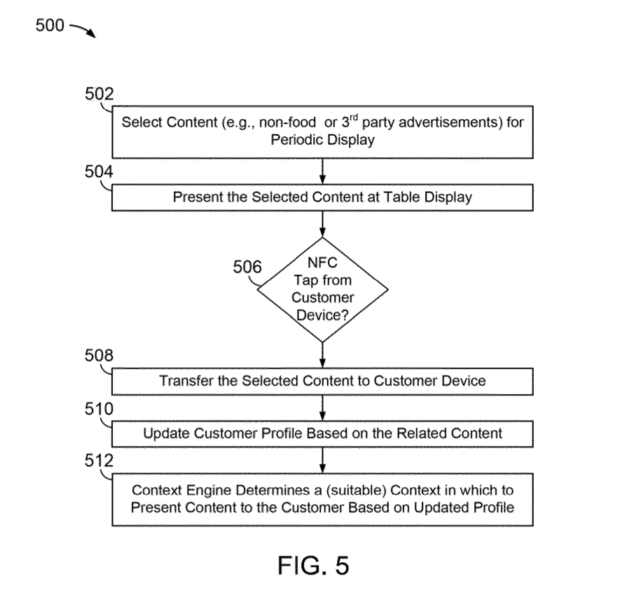

FIG. 5 is a flowchart of a method 500 of presenting content to a customer at an interactive kiosk, and selectively transferring related content to a mobile customer device based on customer interactions with the kiosk. Method 500 is described below with respect to a dining experience and with reference to environment 100 in FIG. 1. Method 500 is not, however, limited to dining experiences or environment 100.

At 502, content is presented at a display of kiosk 101. In a restaurant environment, the content may relate to other than a restaurant menu, such as other goods, services, and/or special offers of the restaurant, and/or goods and/or services available from a 3^{rd} party vendor/advertiser. The content may include advertisements/offers for such goods and/or services.

Presenting content at 502 may include selecting or targeting the content based on customer context. Customer context may be determined based at least in pan on a profile of customer 110, such as described in one or more examples herein.

At 504, the selected content is presented at display 104 of kiosk 101.

At 506, if customer 110 taps customer device 112 to NFC device 106 while the content is presented at display 104, the content (or related content) is transferred to customer device 112 at 508. For example, where an advertisement is presented at display 104, the advertisement, or a corresponding computer-based coupon is transferred to customer device 112. The content may be transferred from kiosk 101 to customer device 112 through respective NFC devices.

At 510, the profile of customer 112 is updated to reflect that the customer expressed an interest in and/or a preference with respect to the content at 506.

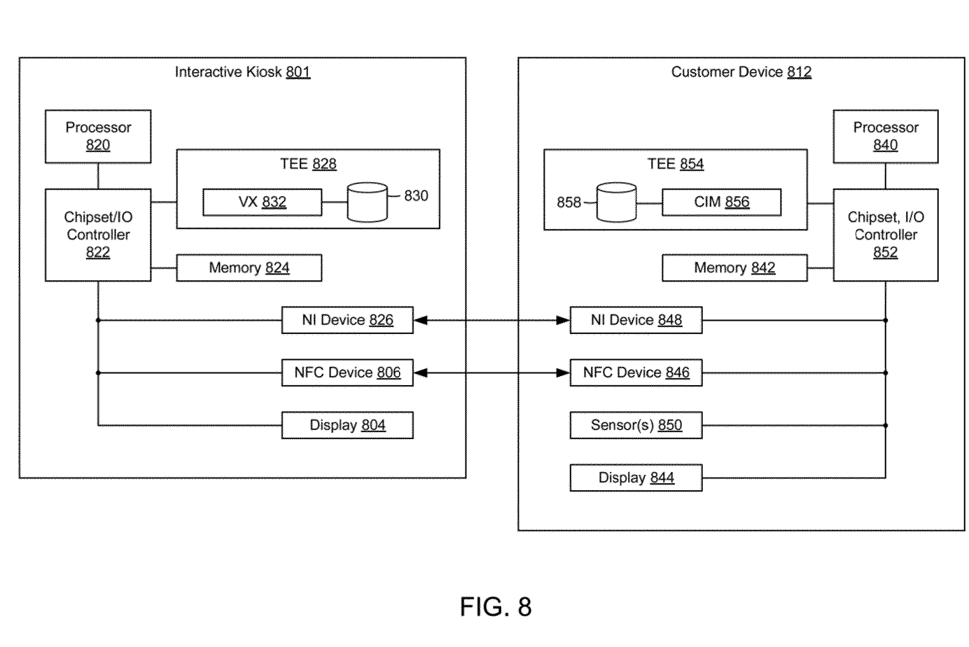

At 512, a context engine determines a suitable context in which to present content to customer 110 based on the updated profile of customer 112. This may represent a refinement of the selection process described above with reference to 502. The context engine may reside on customer device 112, kiosk 101, vendor server system 108, and/or combinations thereof. Examples are provided further below with reference to FIG. 8.

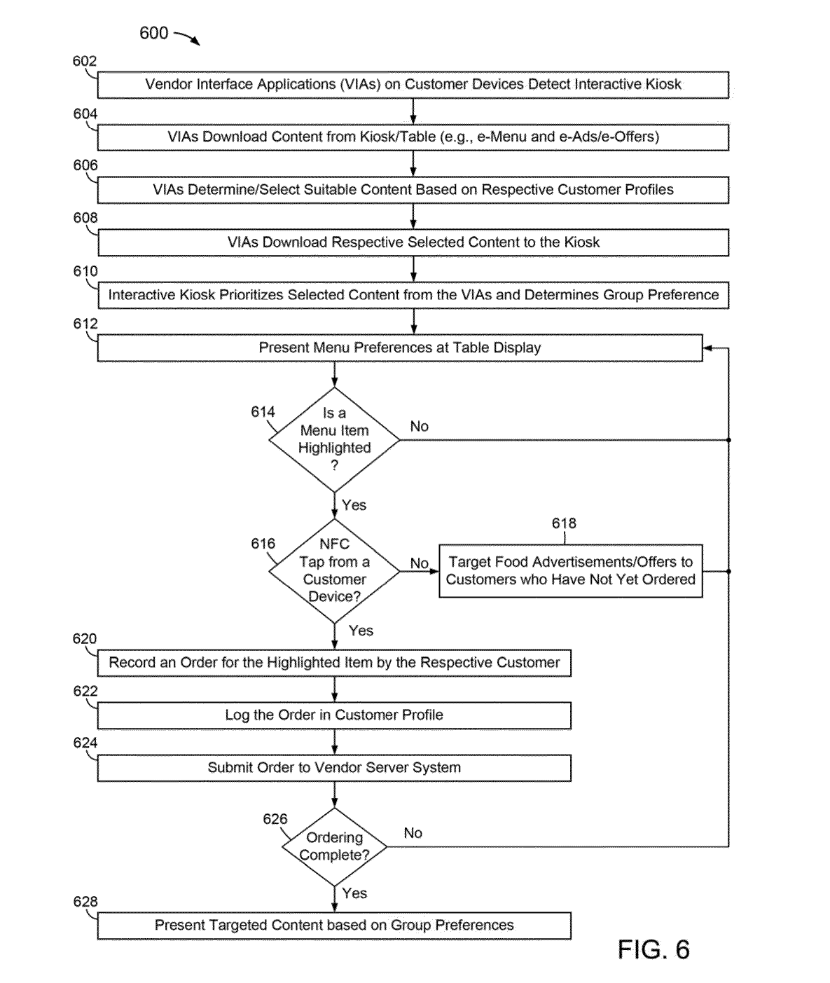

FIG. 6 is a flowchart of a method 600 of interacting amongst an interactive kiosk and multiple customer devices. Method 600 is described below with reference to FIG. 7. Method 600 is not, however, limited to the example of FIG. 7.

FIG. 7 is an illustration of a customer/vendor environment 700 that includes an interactive kiosk (kiosk) 701, devices 712 of respective customers 710, a hostess device 718 associated with a vendor hostess 720, and a wireless access point 709 to access a vendor server system 708, one or more of which may be configured as described above with respect to FIG. 1. In FIG. 7, kiosk 701 includes a user interface, illustrated here as including one or more displays 704. Kiosk 701 further includes multiple NFC devices 706 to interact with customer devices 712 (illustrated here as NFC taps 740-746).

At 602 of FIG. 6, vendor interface applications (VIAs) on customer devices 712 detect kiosk 701 (e.g., via WiFi, Bluetooth, RFID, NFC, and/or other near field technique).

At 604, the VIAs on customer devices 712 download content from kiosk 701, and/or from vendor server system 708. The content may include menu items, advertisements, and/or offers.

At 606, each VIA selects a subset of the downloaded content based on interests and/or preferences of the respective customer 710, with or without input from the respective customer. For example, and without limitation, menu items may be selected (or hidden/omitted) based on interests and/or preferences of a customer 710. The interests and/or preferences may be maintained within customer profile on the respective customer device 712.

At 608, the VIAs provide the respective selections to kiosk 701 (e.g., via taps of respective NFC devices).

At 610, kiosk 701 prioritizes the selections received from the VIAs, and selects or determines group-based preferences (e.g., group-based menu preferences and/or advertisement/offer preferences), based on the selections received from the VIAs at 608. The group-based preferences may represent a group context.

At 612, kiosk 701 presents a group-based menu or menu preferences at display(s) 704. Kiosk 701 may present menu items in a traditional menu format and/or in another format(s). Kiosk 701 and/or display 704 may include controls (e.g., touch screen controls), to permit customers 712 to navigate through the menu items, such as to highlight menu items at 614.

At 616, if a customer device 712 is tapped to a NFC device 706 while a menu item is highlighted at 614, the highlighted item is recorded as an order by the respective customer at 620. Related content may also be downloaded to the customer device (e.g., an icon of the highlighted item and/or additional information regarding the highlighted item), and the customer may be permitted to order the item with a subsequent motion/action (e.g., selecting the icon at the customer device and/or responding to a prompt from kiosk 701).

At 622, the order is logged in the respective customer profile on the customer device.

At 624, the order is submitted to vendor server system 608.

At 618, a NFC tap is not detected at 616, and/or until a NFC tap is detected while a menu item is highlighted, targeted food advertisements/offers may be presented at kiosk 701. The food advertisements/offers may be targeted to the entire group of customers, or to a subset of the group of customers (e.g., to customers who have not yet placed an order). The food advertisements/offers may be related or unrelated to the menu item highlighted at 614.

At 626, if ordering is complete, targeted content (e.g., 3^{rd} party advertisements/offers), processing proceeds to 628, where targeted content is presented at kiosk 701 based on a group preference or group context determined at 610.

Example techniques to determine a customer context and a group context are provided below.

In FIG. 1, where a single customer 110 is at kiosk 101, the VIA on customer device 112 may permit customer 110 to select attributes of a personal profile for use in targeting content to customer 110, and/or to select content (e.g., advertisements) that customer 110 deems appropriate for presentation at display 104 over the course of a dining experience. The VIA may be configured to provide the profile attribute and/or advertisement selections to kiosk 101 via respective NFC devices.

Content that is suitable when customer 110 dines alone or dines with a first group of customer (e.g., members of a softball team) may not be suitable when customer 110 dines with a second group (e.g., work colleagues, family, or members of a religious organization). Thus, where a group of customers 710 is seated at table 702 in FIG. 7, it may be useful to determine or define a group context based on profile attributes and/or advertisements that all members of the group deem appropriate for the setting.

For example, where family members are celebrating a life event, such as a wedding, suitable subject matter for advertisements may be determined to include champagne, department store registration, and/or introductory financial planning services. For a company party, on the other hand, suitable subject matter for advertisements may be determined to champagne but not department store registration or financial planning services.

Group context may be determined by having each customer select attributes of his/her respective personal profile and/or advertisements that each customer deems appropriate for the group setting. An attribute or advertisement selected by a first threshold number of members of the group (e.g., most or all member), may be used to target content to the group. An attribute or advertisement that is declined by a second threshold number of the members (e.g., by any one member of the group), may be omitted from use in targeting content to the group.

A customer may consider his/her profile attribute and/or advertisement selections to be private. The customer may thus object to disclosure of his/her attribute/advertisement selections to other customers to protect his/her privacy and/or to avoid ridicule, ostracism, and/or a potentially socially awkward situation if another member(s) of the group finds an attribute/advertisement selection of the customer to be objectionable and/or offensive. The customer may also object to disclosure of his/her attribute/advertisement selections to the kiosk out of concern that it will be shared with the vendor/restaurant and/or 3^{rd} party vendors advertisers.

In an embodiment, each VIA running on a customer device is configured to a participate in an additive homomorphic vote encryption protocol, through respective field communication (NFC) devices, to provide an encrypted vote tally to a kiosk, without disclosing votes of individual customers to other customers or to the kiosk.

Each VIA may be configured to permit the respective customer to privately select (i.e., vote on) profile attributes and/or advertisements that the customer is willing to have considered in targeting content to a group of customers.

Profile attribute/advertisement selections of individual customers are accessible to the VIM of the respective customer devices to conduct voting protocols that identify common interests/preferences for targeting content (e.g., advertisements), that is agreeable to/suitable for the group based on a context of the group gathering (e.g., dining event). The profile attribute/advertisement selections of the individual customers are not communicated to the kiosk or amongst the customers of the group.

Additive homomorphic encrypted vote tallying may be useful to protect privacy of a customer with respect to a kiosk, a vendor, 3^{rd} party advertises, and/or other customers. Decrypted vote tallies may serve as a group context, or be used to determine or define a group content.

Group context and content targeting is thus determined and/or refined based on profile information and/or advertisement selections contained within NFC capable mobile devices of the respective customers.

FIG. 8 is a block diagram of an interactive kiosk (kiosk) 801 and a customer device 812, which are configured to conduct or perform private voting and additive homomorphic encryption vote tallying.

Kiosk 801 includes a NFC device 806 and a customer interface, illustrated here as a display 804, such as described above with respect to NFC device 106 and display 104 in FIG. 1.

Kiosk 801 further includes a wireless network interface device 826 (e.g., a WiFi, Bluetooth and/or other packet-based and/or far field transceiver), to communicate with a vendor server system through a wireless access point, such as described above with reference to vendor server system 108 and wireless access point 109 in FIG. 1.

Kiosk 801 further includes a processor 820 and memory 824 configured (e.g., with a vendor computer program) to interface with VIAs of customer devices, including customer device 812.

Kiosk 801 further includes a chipset input/output (chipset/IO) controller 822 to interface between processor 820 and physical resources of kiosk 801 (e.g., memory 824, display 804, NFC device 806, and wireless network interface device 826).

Kiosk 801 may be configured to execute a vendor experience (VX) application 832 in a trusted execution environment TEE 828 that is secure from (I.e., inaccessible to), other applications and/or an operating system of processor 820. VX application 832 may include instructions to cause a processor to participate in an additive homomorphic vote encryption protocol with customer device 812 and/or other customer devices, such as described further below. VX application 832 may represent all or a portion of (i.e., a subset of instructions of) a vendor application that executes on processor 820.

TEE 828 may be configured within a secure portion or region of processor 820 and/or an access-protected region of memory 824, and/or may represent a device or module (e.g., another processor and/or memory) that is inaccessible to applications and/or an operating system of processor 820. Such a device or module is referred to herein as a secure module. A secure module may be accessible to processor 820 and/or chipset/IO though an out-of-bound (OOB) channel (e.g., a channel that is accessible to processor 820 when execution of applications and/or an operating system on processor 820 is halted or suspended). The OOB channel may be accessible to processor 820 in a system management mode (i.e., in response to a system management mode interrupt (SMI)), and/or upon exiting a virtual machine (VM) in which other application(s) and/or an operating system executes on processor 820.

TEE 828 may be include and/or may be configured as a dedicated trusted execution module, a management engine (e.g., an Intel® Manageability Engine (ME)), a cryptographic security engine (CSE), and/or software guard extensions (SGX) to construct TEE 828 within processor 820. Kiosk 910 may also include software guard extensions to construct a TEE within a processor of customer device 812.

Customer device 812 includes a processor 840 and memory 842 configured (e.g., with a VIA) to interface with interactive kiosk 801, such as described above with respect to FIG. 1.

Customer device 812 further includes a user interface that includes a display 844 to present a user interface to the VIA. Customer device 812 further includes a NFC device 846 to interface with NFC device 806, and a wireless network interface 848 to interface with a wireless access point of a vendor server system, such as described above with respect to wireless access point 109 in FIG. 1.

Customer device 812 may further include one or more sensors 850 to sense real-time contextual information, such as environmental and/or customer biological condition(s).

Customer device 812 further includes a chipset/IO (input/output) controller 852 to interface between processor 840 and physical resources of customer device 812 (e.g., memory 842, display 844, NFC device 846, wireless network interface device 848, and sensor(s) 850).

Customer device 812 may be configured to execute a context information manager (CIM) application 856 in a trusted execution environment 854, such as described above with respect to TEE 828. CIM application 856 may include instructions to cause a processor to apply privacy objectives of a customer based on additive-homomorphic encryption. CIM application 856 may represent all or a portion of (i.e., a subset of instructions of) a VIA that executes on processor 840.

Customer device 812 may configured to store contextual information (e.g., customer profile information, customer preferences, information from sensor(s) 850, and/or profile attribute/advertisement selections/votes of the customer), in secure storage 858.

Kiosk 801 may be configured to receive and store the contextual information, or a portion thereof (e.g., sensor information and profile attribute/advertisement selections/votes), within secure storage 830.

Secure storage 830 may represent an access-protected region of memory 824, dedicated TEE memory, and/or other access-restricted storage media that is accessible from within TEE 828.

Secure storage 858 may represent an access-protected region of memory 842, dedicated TEE memory, and/or other access-restricted storage media that is accessible from within TEE 854.

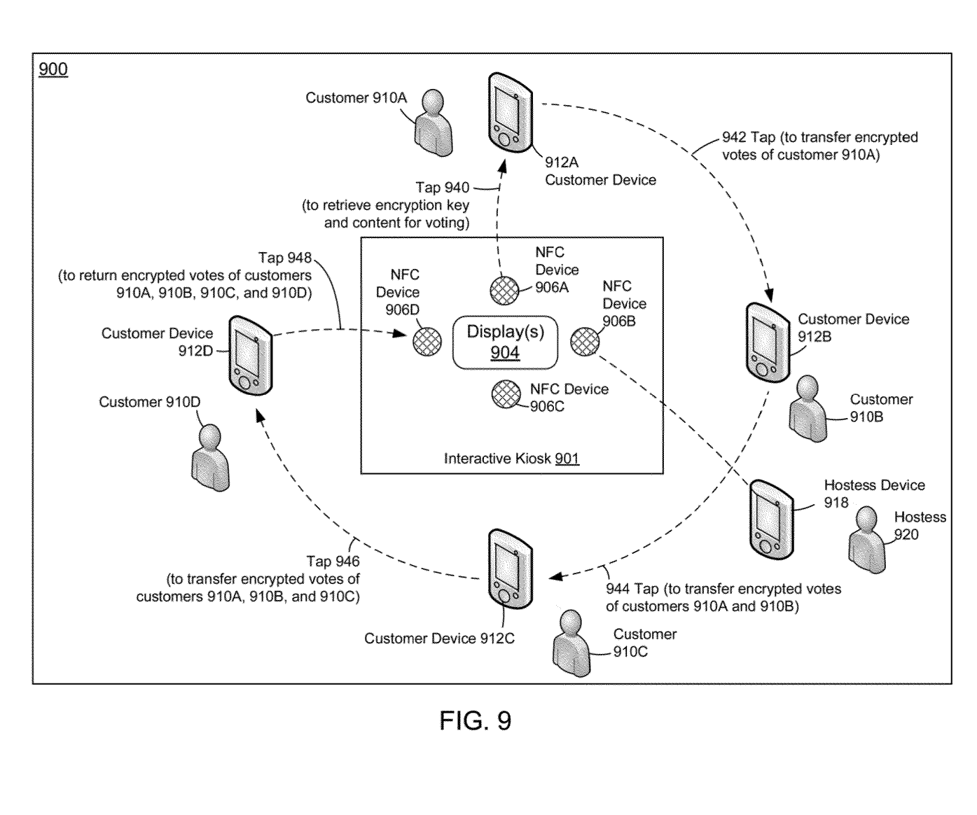

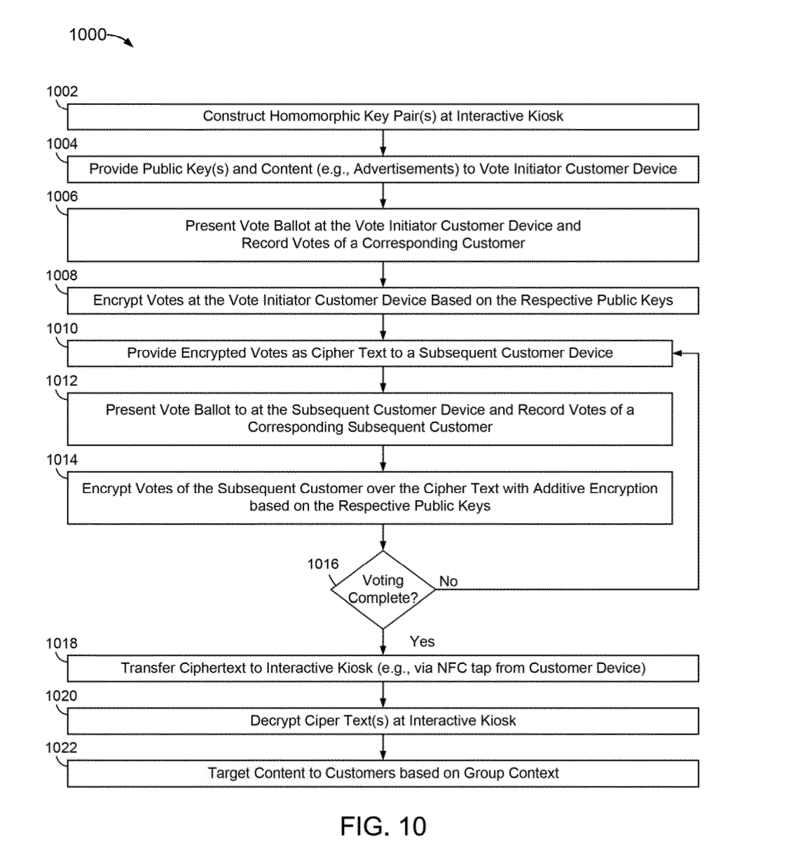

VX 832 may be configured to initiate an additive homomorphic encrypted voting protocol amongst CIM 856 and CIMs of other customer devices, and to determine a group context based on a vote tally, such as described below with reference to FIGS. 9 and 10. VX 832 and/or a vendor computer program of kiosk 801 may be configured to select or target content (e.g., menu items and/or advertisements/offers) to customers based on the group context.

FIG. 9 is an illustration of a customer/vendor environment 900 that includes an interactive kiosk 901, devices 912 of respective customers 910, and a hostess device 918 associated with a vendor hostess 920. Kiosk 901 a user interface, illustrated here as including one or more displays 904. Kiosk 901 further includes multiple NFC devices 906.

Kiosk 901 and/or customer devices 910 may be configured as described above with respect to kiosk 801 and customer device 810 FIG. 8.

Kiosk 901 and customer devices 910 may be configured to participate in an additive homomorphic vote encryption protocol, and kiosk 901 may be further select/target content to customers 910 based on a decrypted vote tally, such as described below with respect to FIG. 10.

FIG. 10 is a flowchart of a method 1000 of determining a group context based on additive homomorphic vote encryption, and selecting/targeting content (e.g., menu items and/or advertisements/offers) based on the group context. Additive homomorphic encrypted voting may be useful to determine a group context without disclosing selections/votes of individual customers to other customers, to a vendor/restaurant kiosk, and/or 3^{rd} party advertisers.

For illustrative purposes, additive homomorphic encrypted voting is performed in method 1000 with respect to attributes of customer profiles and advertisements of multiple advertisers. In another embodiment(s), additive homomorphic encrypted voting may be performed with respect to profile attributes, advertisements of a single advertiser, advertisements of multiple advertisers, or other type(s) of contextual information, alone and/or in various combinations with one another.

Method 1000 is described below with reference to customer/vendor environment 900 in FIG. 9. Method 1000 is not, however, limited to the example FIG. 9. Features described below with respect kiosk 901 in FIG. 9 may be performed by a vendor program on processor 820 and/or by VX 832 in TEE 828 of FIG. 8. Features described below with respect to a customer device 912 in FIG. 9 may be performed by a VIA on processor 840 and/or by CIM 856 in TEE 854 of FIG. 8.

At 1002, kiosk 901 constructs one or more homomorphic key pairs for customers 910. Kiosk 901 may be configured to limit lifetimes of the key pair(s) to a session associated with customers 910 (e.g., dining session of customers 910). Kiosk 901 may, for example, be configured to delete the key pair(s) upon payment of a bill associated with customers 910.

At 1004, kiosk 901 provides a public group profile voting key (GPVK), advertisements of multiple advertisers, and corresponding public advertiser keys (PK_{advn}), to customer device 912A. The advertisements and public advertiser keys may represented as:

ADS=[(PK_{adv1},Ad1_{adv1},Ad2_{adv1} . . . ),(PK_{adv2},Ad1_{adv2},Ad2_{adv2}, . . . ) . . . (PK_{advn},Ad1_{advn},Ad2_{advn}, . . . )], EQ. (1)

where,
PK_{adv1}, PK_{adv2}, and PK_{advn}, represent public keys associated with respective advertisers 1 through m;
“Ad1_{adv1}, Ad2_{adv1} . . . ” represents advertisements of the first advertiser;
“Ad1_{adv2}, Ad2_{adv2} . . . ” represents advertisements of the second advertiser; and
“Ad1_{advm}, Ad2_{advm} . . . ” represents advertisements of the m^{th} advertiser.

Kiosk 901 may provide the public keys to customer device 912A in response to a NFC tap 940 between customer device 912A and NFC device 906. In FIG. 8, the public keys may be transferred from TEE 828 of kiosk 801 to TEE 854 of customer device 812, via respective NFC devices 806 and 848.

At 1006, customer device 912A presents the advertisements and attributes of a personal profile of customer 910A as a vote ballot, to permit customer 910A to select attributes and advertisements for use in determining a group context for customers 910 (e.g., by voting yes or no for each profile attribute and advertisement).

At 1008, customer device 912A encrypts votes of customer 910A based on the respective public keys. For illustrative purposes, in examples below, a “yes” vote is represented as a 1, and a “no” vote is represented as a 0.

Encrypted advertisements votes of customer 910A may be arranged as an array, and may be represented as:

EV=[E(PK_{adv1},(0*Ad1_{adv1}),(1*Ad2_{adv1}) . . . ),(PK_{adv2},(1*Ad1_{adv2}),(0*Ad2_{adv2}) . . . ) . . . E(PK_{advm},(0*Ad1_{advm}),(PK_{advm},(0*Ad2_{advm}) . . . )] EQ. (2)

Profile attributes votes of customer 910A may also be arranged as an array and encrypted using public attribute encryption key (PK_{TDD}).

Encrypted profile attribute votes of customer device 912A may be represented as:

EV2=[E(PK_{TDD},(0*D1),(1*D2) . . . (0*Di) . . . ), EQ. (2)

where D1 through Di represent respective profile attributes.

At 1010, customer device 912A provides the encrypted votes of customer 910A as cipher text(s) to customer device 912B. The cipher text(s) may be provided via respective NFC devices based on a NFC tap 942.

The advertisements and public key(s) provided to customer device 910A at 1006 may be provided to customer device 910B by customer device 912A and/or kiosk 901 (e.g., via respective NFC devices).

At 1012, customer device 912B presents the advertisements and attributes of a personal profile of customer 910B as a vote ballot, to permit customer 910B select attributes and advertisements to be used in determining a group context for customers 910.

At 1014, customer device 912B encrypts votes of customer 910B with additive encryption over the cipher text received from customer device 912A. This may be represented as:

EV′=[E(EV1+EV2)=EV1:E(PK_{adv1},x1)+EV2:E(PK_{adv1},x1) . . . ] EQ. (3)

As illustrated in Table 1 below, if customer 910A and customer 910B vote for an attribute or advertisement Q₁ the addition operation of EQ. 3 sums the cipher texts to provide a value cipher text incremented by 2. If customer 910A votes for an attribute or advertisement Q₂ and customer 910B votes against Q₂, or if customer 910B votes for an attribute or advertisement Q₃ and customer 910A votes against Q₃, the corresponding vote or value cypher text is incremented by 1. If customer 910A and customer 910B vote against an attribute or advertisement Q₄, there is no change to the cipher texts (i.e., zero added to zero is zero).

TABLE 1

| | Vote of | Vote of | Cipher Text |
|---|---|---|---|
| Feature | Customer 910A | Customer 910B | Addition/Increment |
| Q₁ | Yes | Yes | 2 |
| Q₂ | Yes | No | 1 |
| Q₃ | No | Yes | 1 |
| Q₄ | No | No | 0 |

At 1016, processing returns to 1010, where customer device 912B provides the additive encrypted votes of customers 910A and 910B as cipher text to customer device 912C. The cipher text(s) may be transferred via respective NFC devices in response to a NFC tap 944 between customer devices 912B and 912C.

At customer device 912C, 1012 and 1014 are performed to encrypt votes of customer 910C with additive encryption over the cipher text received from customer device 912B.

Processing then returns to 1010, where customer device 912C provides the additive encrypted votes of customers 910A, 910B, and 910C as cipher text to customer device 912D (e.g., via respective NFC devices in response to a NFC tap 946).

At customer device 912D, 1012 and 1014 are performed to encrypt votes of customer 910D with additive encryption over the cipher text received from customer device 912C.

At 1018, customer device 912D provides the additive encrypted votes of customers 910A, 910B, 910C, and 910D as cipher text to kiosk 901 (e.g., via respective NFC devices in response to a NFC tap 948).

At 1020, kiosk 901 decrypts the cipher text using private key(s) generated at 1002 (e.g., PK_{TDD}, PK_{adv1}, PK_{adv2}, . . . K_{advm}), to determine vote tallies for the profile attributes and advertisements.

At 1022, kiosk 901 selects/targets content (e.g., menu items and/or advertisements/offers) to customers 912 based on the vote tallies, alone or in combination with other contextual information and/or factors (e.g., information from sensor(s) 850 in FIG. 8).

Method 1000 may be repeated over the course of a dining session, such as to refine the selection of content targeted to customers 910.

As an example, and without limitation, content may be selected for presentation at kiosk 901 based on a relationship (e.g., similarity and/or dissimilarity) between the content and profile attributes and/or advertisements associated with a customer context or a group context (e.g., similarity or dissimilarity between the content and profile attribute and/or advertisement selections for which all of customers 910A through 910D voted “yes”).

One or more features disclosed herein may be implemented in, without limitation, circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof. Information processing by software may be concretely realized by using hardware resources.

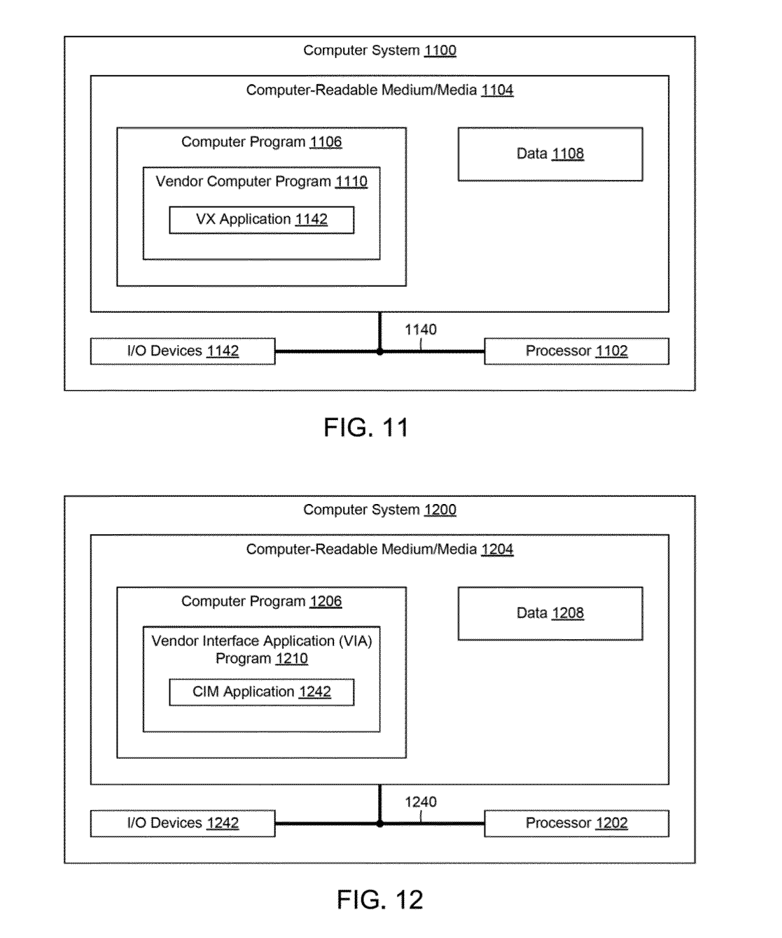

FIG. 11 is a block diagram of computer system 1100, configured as an interactive kiosk computer system.

Computer system 1100 includes one or more processors, illustrated here as a processor 1102, to execute instructions of a computer program 1106 encoded within a computer-readable medium 1104. Processor 1102 may represent processor 820 in FIG. 8 and/or another processor to provide trusted execution environment (TEE) 828.

Processor 1102 may include one or more instruction processors and/or processor cores, and a control unit to interface between the instruction processor(s)/core(s) and computer readable medium 1104. Processor 1102 may include, without limitation, a microprocessor, a graphics processor, a physics processor, a digital signal processor, a network processor, a front-end communications processor, a co-processor, a management engine (ME), a controller or microcontroller, a central processing unit (CPU), a general purpose instruction processor, and/or an application-specific processor.

Computer readable medium 1104 may include a transitory or non-transitory computer-readable medium. Computer readable medium 1104 may represent memory 824 and/or secure storage 830 in FIG. 8.

In FIG. 11, computer readable medium 1104 is encoded with a computer program 1106 to be executed by processor 1102. Computer-readable medium 1104 further includes data 1108, which may be used by processor 1102 during execution of computer program 1106, and/or generated by processor 1102 during execution of computer program 1106.

In the example of FIG. 11, computer program 1106 includes a vendor computer program 1110 that includes instructions to cause processor 1102 to interface with customer devices, such as described in one or more examples herein.

Computer system 1100 may be configured to execute vendor application 1110, or a portion thereof (e.g., VX application 1112), in a trusted execution environment, such as described above with reference to TEE 828 in FIG. 8.

Computer system 1100 further includes communications infrastructure 1140 to communicate amongst devices and/or resources of computer system 1100, such as described above with respect to chipset/IO controller 822 in FIG. 8.

Computer system 1100 further includes one or more input/output (IO) devices and/or controllers, illustrated here as I/O devices 1142, to interface with one or more other systems and/or devices. With reference to FIG. 8, I/O devices 1140 may represent near field device 806, network interface device 826, and/or a display interface to interface with display 804.

FIG. 12 is a block diagram of computer system 1200, configured as a user or customer device.

Computer system 1200 includes one or more processors, illustrated here as a processor 1202, to execute instructions of a computer program 1206 encoded within a computer-readable medium 1204. Processor 1202 may represent processor 812 in FIG. 8 and/or another processor to provide trusted execution environment (TEE) 854.

Processor 1202 may include one or more instruction processors and/or processor cores, and a control unit to interface between the instruction processor(s)/core(s) and computer readable medium 1204, such as described above with reference to processor 1102 in FIG. 11.

Computer readable medium 1204 may include a transitory or non-transitory computer-readable medium. Computer readable medium 1204 may represent memory 842 and/or secure storage 858 in FIG. 8.

In FIG. 12, computer readable medium 1204 is encoded with a computer program 1206 to be executed by processor 1202. Computer-readable medium 1204 further includes data 1208, which may be used by processor 1202 during execution of computer program 1206, and/or generated by processor 1202 during execution of computer program 1206.

In the example of FIG. 12, computer program 1206 includes a vendor interface application (VIA) program 1210 that includes instructions to cause processor 1202 to interface with an interactive kiosk(s) and other customer devices, such as described in one or more examples herein.

Computer system 1200 may be configured to execute VIA program 1210, or a portion thereof (e.g., CIM application 1212), in a trusted execution environment, such as described above with reference to TEE 828 in FIG. 8.

Computer system 1200 further includes communications infrastructure 1240 to communicate amongst devices and/or resources of computer system 1200, such as described above with respect to chipset/IO controller 852 in FIG. 8.

Computer system 1200 further includes one or more input/output (I/O) devices and/or controllers, illustrated here as IO devices 1242, to interface with one or more other systems and/or devices. With reference to FIG. 8, I/O devices 1240 may represent near field device 846, network interface device 848, a display interface to interface with display 844, and/or a device(s) to interface with sensor(s) 850.

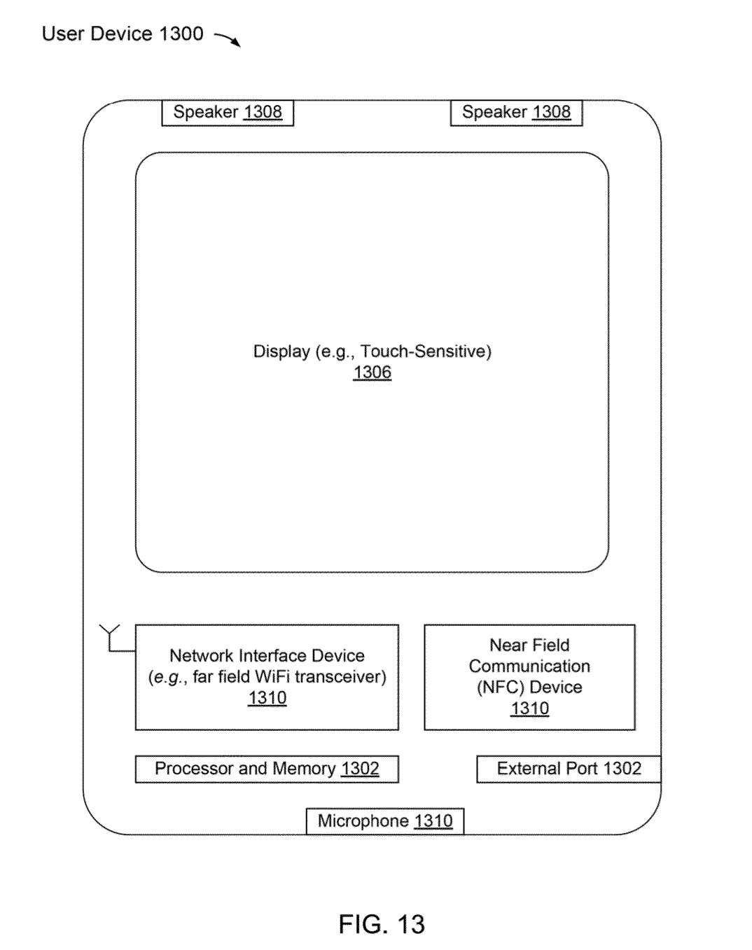

A customer device as described herein may be configured as a mobile device, such as described below with reference to FIG. 13. Methods and systems disclosed herein are not, however, limited to the examples below.

FIG. 13 is a block diagram of a mobile device 1300, including a processor and memory 1302, a NFC device 1310, and a network interface device 1312. Mobile device 1300 further includes a user interface, illustrated here as including a display 1306, speakers 1308, and a microphone 1310.

Mobile device 1300 may be configured to interface with an interactive kiosk(s) and other mobile devices, such as described in one or more examples herein. Customer device 1300 may be further configured as, without limitation, smart device, a mobile personal communication device, and/or a laptop, notebook, netbook, note pad, and/or other mobile computer device.

### EXAMPLES

The following examples pertain to further embodiments.

Example 1 is a machine-implemented method that includes participating, as one of a first mobile user device and a kiosk, in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

In an Example 2, the participating includes participating as the first mobile user device, including presenting a vote ballot at a user interface of the first mobile user device, receive corresponding votes of a user, and encoding the votes of the user as first cypher text based on a public encryption key, receiving the public encryption key from the kiosk through respective NFC devices and providing the first cypher text to a third user device through respective NFC devices, when acting as vote initiator device, and receiving the public encryption key and second cypher text from a third mobile user device through respective NFC devices, combining the first and second cypher texts based on additive encryption, and providing the combined cypher texts to one of a fourth mobile user device and the kiosk through respective NFC devices, when acting as subsequent vote device.

In an Example 3, further to Example 2, the participating of Example 2 includes presenting attributes of a personal profile of the user in the vote ballot.

In an Example 4, further to Example 2, the public encryption key includes a public attribute encryption key, the presenting includes presenting attributes of a personal profile of the user in the vote ballot, the receiving corresponding votes of a user includes receiving attribute votes of the user, and the encoding includes encoding each attribute vote of the user within the first cypher text based on the public attribute encryption key.

In an Example 5, further to Example 2, the public encryption key includes a public advertiser encryption key for each of one or more advertisers; the participating as the first mobile user device further includes receiving advertisements of the one or more advertises from the kiosk through the respective NFC devices when acting as the vote initiator device, and receiving the advertisements of the one or more advertises from the third mobile user device through the respective NFC devices when acting as the subsequent vote device; the presenting includes presenting the advertisements in the vote ballot; the receiving corresponding votes of a user includes receiving advertisement votes of the user; and the encoding includes encoding each advertisement vote of the user within the first cypher text based on the public advertiser encryption key of the respective advertiser.

In an Example 6, further to Example 5, the public encryption key further includes a public attribute encryption key, the presenting includes presenting attributes of a personal profile of the user in the vote ballot, the receiving corresponding votes of a user includes receiving attribute votes of the user, and the encoding includes encoding each attribute vote of the user within the first cypher text based on the public attribute encryption key.

In an Example 7, further to Example 1, the participating includes participating as the kiosk, including decrypting the tally of votes, and selecting content to present at a kiosk-based user interface based on the decrypted tally of votes.

In an Example 8, further to Example 7, the selecting content includes one or more of selecting menu items of a vendor associated with the kiosk, and selecting advertisements associated with one or more of the vendor and another vendor.

In an Example 9, further to Example 7, the method further includes presenting introductory information to customers through a user interface of the kiosk if a mobile device associated with a vendor hostess is positioned within a near field of the NFC device of the kiosk.

In an Example 10, further to Example 7, the method further includes presenting a vendor menu at a user interface of the kiosk, and selectively transferring one or more of an icon associated with a menu item and information associated with the menu item to a mobile user device through respective NFC devices if the user device is within a near field of a kiosk-based NFC device when the menu item is presented.

In an Example 11, further to Example 7, the method further includes presenting advertisements at a user interface of the kiosk, and transferring an advertisement from the kiosk to a mobile user device through respective NFC devices if the user device is within a near field of a kiosk-based NFC device when the advertisement is presented.

An Example 12 is an apparatus configured to perform the method of any one of Examples 1-11.

An Example 13 is an apparatus that includes means for performing the method of any one of Examples 1-11.

An Example 14 is a machine-readable medium that includes a plurality of instructions that, when executed on a computing device, cause the computing device to carry out the method of any one of Examples 1-11.

An Example 15 is a communications device arranged to perform the method of any one of Examples 1-11.

An Example 16 is a computer system to perform the method of any one of Examples 1-11.

An Example 17 is a machine to perform the method of any one of Examples 1-11.

An Example 18 is a computing device that includes a chipset according any one of Examples 1-11.

An Example 19 is an apparatus that includes a machine configured as one of a first mobile user device and a kiosk to participate in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

In an Example 20, further to Example 19, the machine is configured as the first mobile user device to present a vote ballot at a user interface of the first mobile user device, receive corresponding votes of a user, and encode the votes of the user as first cypher text based on a public encryption key, receive the public encryption key from the kiosk through respective NFC devices and provide the first cypher text to a third user device through respective NFC devices, when acting as vote initiator device, and receive the public encryption key and second cypher text from a third mobile user device through respective NFC devices, combine the first and second cypher texts based on additive encryption, and provide the combined cypher texts to one of a fourth mobile user device and the kiosk through respective NFC devices, when acting as subsequent vote device.

In an Example 21, further to Example 20, the public encryption key includes a public attribute encryption key, and the first mobile user device is configured to present attributes of a personal profile of the user in the vote ballot, receive corresponding attribute votes of the user, and encode each attribute vote of the user within the first cypher text based on the public attribute encryption key.

In an Example 22, further to Example 20, the public encryption key includes a public advertiser encryption key for each of one or more advertisers, and the first mobile user device is configured to receive advertisements of the one or more advertises from the kiosk through respective NFC devices when acting as the vote initiator device, receive the advertisements of the one or more advertises from the third mobile user device through respective NFC devices when acting as the subsequent vote device, and present the advertisements in the vote ballot, receive corresponding advertisement votes of the user, and encode each advertisement vote of the user within the first cypher text based on the public advertiser encryption key of the respective advertiser.

In an Example 23, further to Example 22, the public encryption key further includes a public attribute encryption key, and the first mobile user device is further configured to present attributes of a personal profile of the user in the vote ballot, receive corresponding attribute votes of the user, and encode each attribute vote of the user within the first cypher text based on the public attribute encryption key.

In an Example 24, further to Example 19, the machine is configured as the kiosk to decrypt the tally of votes, and to select content to present at a kiosk-based user interface based on the decrypted tally of votes.

In an Example 25, further to Example 24, the kiosk is configured to select the content from one or more of menu items of a vendor associated with the kiosk, and advertisements associated with one or more of the vendor and another vendor.

In an Example 26, further to Example 24, the kiosk is further configured to present introductory information to customers through a user interface of the kiosk if a mobile device associated with a vendor hostess is positioned within a near field of the NFC device of the kiosk.

In an Example 27, further to Example 24, the kiosk is further configured to present menu items of a vendor at a user interface of the kiosk, and transfer one or more of an icon associated with a menu item and information associated with the menu item to a mobile user device through respective NFC devices if the user device is within a near field of a kiosk-based NFC device when the menu item is presented.

In an Example 28, further to Example 24, the kiosk is further configured to present advertisements at a user interface of the kiosk, and transfer an advertisement from the kiosk to a mobile user device through respective NFC devices if the user device is within a near field of a kiosk-based NFC device when the advertisement is presented.

An Example 29 is a non-transitory computer readable medium encoded with a computer program that includes instructions to cause a processor of one of a first mobile user device and kiosk to participate in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

In an Example 30, the computer program includes instructions to cause a processor of the first mobile user device to present a vote ballot at a user interface of the first mobile user device, receive corresponding votes of a user, and encode the votes of the user as first cypher text based on a public encryption key, receive the public encryption key from the kiosk through respective NFC devices and provide the first cypher text to a third user device through respective NFC devices, when acting as vote initiator device, and receive the public encryption key and second cypher text from a third mobile user device through respective NFC devices, combine the first and second cypher texts based on additive encryption, and provide the combined cypher texts to one of a fourth mobile user device and the kiosk through respective NFC devices, when acting as subsequent vote device.

In an Example 31, further to Example 30, the non-transitory computer readable medium further includes instructions to cause the processor of the first mobile user device to present attributes of a personal profile of the user in the vote ballot.

In an Example 32, further to Example 30, the public encryption key includes a public advertiser encryption key for each of one or more advertisers, and the non-transitory computer readable medium further including instructions to cause the processor of the first mobile user device to receive advertisements of the one or more advertises from the kiosk through respective NFC devices when acting as the vote initiator device, receive the advertisements of the one or more advertises from the third mobile user device through respective NFC devices when acting as the subsequent vote device, and present the advertisements in the vote ballot, receive corresponding advertisement votes of the user, and encode each advertisement vote of the user within the first cypher text based on the public advertiser encryption key of the respective advertiser.

In an Example 33, further to Example 29, the computer program includes instructions to cause the processor of the kiosk to decrypt the tally of votes and select content to present at a kiosk-based user interface based on the decrypted tally of votes.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. An apparatus, comprising:
a machine configured as one of a first mobile user device and a kiosk to participate in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

2. The apparatus of claim 1, wherein the machine is configured as the first mobile user device to:
present a vote ballot at a user interface of the first mobile user device, receive corresponding votes of a user, and encode the votes of the user as first cypher text based on a public encryption key;
receive the public encryption key from the kiosk through respective NFC devices and provide the first cypher text to a third user device through respective NFC devices, when acting as vote initiator device; and
receive the public encryption key and second cypher text from a third mobile user device through respective NFC devices, combine the first and second cypher texts based on additive encryption, and provide the combined cypher texts to one of a fourth mobile user device and the kiosk through respective NFC devices, when acting as subsequent vote device.

3. The apparatus of claim 2, wherein the public encryption key includes a public attribute encryption key, and wherein the first mobile user device is configured to:
present attributes of a personal profile of the user in the vote ballot;
receive corresponding attribute votes of the user; and
encode each attribute vote of the user within the first cypher text based on the public attribute encryption key.

4. The apparatus of claim 2, wherein the public encryption key includes a public advertiser encryption key for each of one or more advertisers, and wherein the first mobile user device is configured to:
receive advertisements of the one or more advertises from the kiosk through respective NFC devices when acting as the vote initiator device;
receive the advertisements of the one or more advertises from the third mobile user device through respective NFC devices when acting as the subsequent vote device; and
present the advertisements in the vote ballot, receive corresponding advertisement votes of the user, and encode each advertisement vote of the user within the first cypher text based on the public advertiser encryption key of the respective advertiser.

5. The apparatus of claim 4, wherein the public encryption key further includes a public attribute encryption key, and wherein the first mobile user device is further configured to:
present attributes of a personal profile of the user in the vote ballot;
receive corresponding attribute votes of the user; and
encode each attribute vote of the user within the first cypher text based on the public attribute encryption key.

6. The apparatus of claim 1, wherein the machine is configured as the kiosk to decrypt the tally of votes, and to select content to present at a kiosk-based user interface based on the decrypted tally of votes.

7. The apparatus of claim 6, wherein the kiosk is configured to select the content from one or more of:
menu items of a vendor associated with the kiosk; and
advertisements associated with one or more of the vendor and another vendor.

8. The apparatus of claim 6, wherein the kiosk is further configured to present introductory information to customers through a user interface of the kiosk if a mobile device associated with a vendor hostess is positioned within a near field of the NFC device of the kiosk.

9. The apparatus of claim 6, wherein the kiosk is further configured to:
present menu items of a vendor at a user interface of the kiosk; and
transfer one or more of an icon associated with a menu item and information associated with the menu item to a mobile user device through respective NFC devices if the user device is within a near field of a kiosk-based NFC device when the menu item is presented.

10. The apparatus of claim 6, wherein the kiosk is further configured to:
present advertisements at a user interface of the kiosk; and
transfer an advertisement from the kiosk to a mobile user device through respective NFC devices if the user device is within a near field of a kiosk-based NFC device when the advertisement is presented.

11. A non-transitory computer readable medium encoded with a computer program that includes instructions to cause a processor of one of a first mobile user device and kiosk to:
participate in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

12. The non-transitory computer readable medium of claim 11, wherein the computer program includes instructions to cause a processor of the first mobile user device to:
present a vote ballot at a user interface of the first mobile user device, receive corresponding votes of a user, and encode the votes of the user as first cypher text based on a public encryption key;
receive the public encryption key from the kiosk through respective NFC devices and provide the first cypher text to a third user device through respective NFC devices, when acting as vote initiator device; and
receive the public encryption key and second cypher text from a third mobile user device through respective NFC devices, combine the first and second cypher texts based on additive encryption, and provide the combined cypher texts to one of a fourth mobile user device and the kiosk through respective NFC devices, when acting as subsequent vote device.

13. The non-transitory computer readable medium of claim 12, further including instructions to cause the processor of the first mobile user device to present attributes of a personal profile of the user in the vote ballot.

14. The non-transitory computer readable medium of claim 12, wherein the public encryption key includes a public advertiser encryption key for each of one or more advertisers, further including instructions to cause the processor of the first mobile user device to:
receive advertisements of the one or more advertises from the kiosk through respective NFC devices when acting as the vote initiator device;
receive the advertisements of the one or more advertises from the third mobile user device through respective NFC devices when acting as the subsequent vote device; and
present the advertisements in the vote ballot, receive corresponding advertisement votes of the user, and encode each advertisement vote of the user within the first cypher text based on the public advertiser encryption key of the respective advertiser.

15. The non-transitory computer readable medium of claim 11, wherein the computer program includes instructions to cause the processor of the kiosk to:
decrypt the tally of votes; and
select content to present at a kiosk-based user interface based on the decrypted tally of votes.

16. A machine-implemented method, comprising:
participating, as one of a first mobile user device and a kiosk, in a sequential additive homomorphic vote encryption protocol amongst the kiosk, the first mobile user device, and one or more other mobile user devices through respective field communication (NFC) devices to provide an encrypted tally of votes of users of the respective mobile user devices without disclosure of the votes of the users amongst the mobile user devices and without disclosure of the votes of the users to the kiosk.

17. The method of claim 16, wherein the participating includes participating as the first mobile user device, including:
presenting a vote ballot at a user interface of the first mobile user device, receiving corresponding votes of a user, and encoding the votes of the user as first cypher text based on a public encryption key;
receiving the public encryption key from the kiosk through respective NFC devices and providing the first cypher text to a third user device through respective NFC devices, when acting as vote initiator device, and
receiving the public encryption key and second cypher text from a third mobile user device through respective NFC devices, combining the first and second cypher texts based on additive encryption, and providing the combined cypher texts to one of a fourth mobile user device and the kiosk through respective NFC devices, when acting as subsequent vote device.

18. The method of claim 17, wherein the presenting includes presenting attributes of a personal profile of the user in the vote ballot.

19. The method of claim 17, wherein the public encryption key includes a public advertiser encryption key for each of one or more advertisers, and wherein the participating as the first mobile user device further includes:
receiving advertisements of the one or more advertises from the kiosk through respective NFC devices when acting as the vote initiator device; and
receiving the advertisements of the one or more advertises from the third mobile user device through respective NFC devices when acting as the subsequent vote device;
wherein the presenting includes presenting the advertisements in the vote ballot;
wherein the receiving corresponding votes of a user includes receiving advertisement votes of the user; and
wherein the encoding includes encoding each advertisement vote of the user within the first cypher text based on the public advertiser encryption key of the respective advertiser.

20. The method of claim 16, wherein the participating includes participating as the kiosk, including:
decrypting the tally of votes; and
selecting content to present at a kiosk-based user interface based on the decrypted tally of votes.
